(19) United States
(12) Patent Application Publication
(10) Pub. No.: US 2005/0277546 A1
(43) Pub. Date: Dec. 15, 2005

(54) Process for the preparation of a multimetal oxide material

(75) Inventors: Hartmut Hibst, Schriesheim (DE); Frieder Borgmeier, Mannheim (DE); Frank Rosowski, Mannheim (DE); Klaus Joachim Muller-Engel, Stutensee (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/139,657

(22) Filed: May 31, 2005

Related U.S. Application Data
(60) Provisional application No. 60/577,929, filed on Jun. 9, 2004.

(30) Foreign Application Priority Data
Jun. 9, 2004 (DE) 10 2004 027 999.3

(51) Int. Cl. B01J 23/00

(52) U.S. Cl. 502/312

(57) ABSTRACT

A process for the hydrothermal preparation of Mo- and V-comprising multimetal oxide materials, substantially exclusively sources from the group consisting of oxides, hydrated oxides, oxygen acids and hydroxides being used as sources of the elemental constituents of the multimetal oxide material, and a portion of the sources comprising the elemental constituent contained with an oxidation number which is below its maximum oxidation number.

The present invention relates to a process for the preparation of a multimetal oxide material M of the general stoichiometry I
Mo₁VₐM¹_{b}M²_{c}M³_{d}M⁴ₑOₙ (I)
where
M¹=at least one of the elements from the group consisting of Al, Ga, In, Ge, Sn, Pb, As, Bi, Se, Te and Sb;
M²=at least one of the elements from the group consisting of Sc, Y, La, Ti, Zr, Hf, Nb, Ta, Cr, W, Mn, Fe, Co, Ni, Zn, Cd and the lanthanides;
M³=at least one of the elements from the group consisting of Re, Ru, Rh, Pd, Os, Ir, Pt, Cu, Ag and Au;
M⁴=at least one of the elements from the group consisting of Li, Na, K, Rb, Cr, Be, Mg, Ca, Sr, Ba, NH₄ and TI;
a=from 0.01 to 1;
b=from ≧0 to 1;
c=from ≧0 to 1;
d=from ≧0 to 0.5;
e=from ≧0 to 0.5 and
n=a number which is determined by the valency and frequency of the elements other than oxygen in (I),
   in which a mixture G of sources of the elemental constituents of the multimetal oxide material M is subjected to a hydrothermal treatment and the new solid forming thereby is separated off.

Multimetal oxide materials M of the general stoichiometry I and processes for their preparation are known (cf. for example EP-A 318 295, EP-A 512 846, EP-A 767 164, EP-A 865 809, EP-A 529 853, EP-A 608 838, EP-A 962 253, DE-A 102 48 584, DE-A 101 19 933, DE-A 101 18 814, DE-A 100 29 338, DE-A 103 59 027, DE-A 103 21 398, EP-A 1 407 819, Applied Catalysis A: General 194-195 (2000), page 479-485; Applied Catalysis A: General 200 (2000), page 135-143; Chem. Commun. 1999, page 517-518; Res. Chem. Intermed. 26 (2) (2000), page 137-144; Topics Catal. 15 (2001) page 153-160; Catalysis Surveys from Japan 6 (1/2) (2992) 33-44 and Appl. Catal. A: General 251 (2003), page 411-424.

It is also known from the abovementioned prior art that such multimetal oxide materials M are suitable as active materials for catalysts for the heterogeneously catalyzed partial gas-phase oxidation and for the heterogeneously catalyzed partial gas-phase ammoxidation (differs from the straightforward partial gas-phase oxidation substantially through the additional presence of ammonia) of saturated and unsaturated hydrocarbons, alcohols and aldehydes (having, for example, 3 to 8, in particular 2 or 3 and/or 4 carbon atoms). Partial oxidation products thereby are, inter alia, α,β-monoethylenically unsaturated aldehydes (e.g. acrolein and methacrolein) and α,β-monoethylenically unsaturated carboxylic acids (e.g. acrylic acid and methacrylic acid) and the nitriles thereof (e.g. acrylonitrile and methacrylonitrile). The target compounds acrolein, acrylic acid and/or acrylonitrile are obtainable, for example, in the manner described from the hydrocarbons propane and/or propene. Acrolein may also itself be a starting compound for the preparation of the latter two compounds. These target compounds form important intermediates which are used, for example, for the preparation of polymers which can be employed, for example, as adhesives.

In a corresponding manner, methacrolein and methacrylic acid are obtainable from isobutane and isobutene. Methacrolein may also be a starting compound for the preparation of methacrylic acid.

Furthermore, it is known from the evaluated prior art that multimetal oxide materials M occur predominantly in two crystal phases which differ from one another and are referred to in the literature as “i-phase” and as “k-phase”.

The associated X-ray diffractogram is used as a fingerprint of the respective crystal phase, for the characterization thereof and for the characterization of its crystalline structure.

The X-ray diffractogram of the crystalline i-phase contains the following X-ray diffraction pattern RMi, reproduced in the form of interplanar spacings d[Å] independent of the wavelength of the X-rays used

d[Å]
3.06 ± 0.2
3.17 ± 0.2
3.28 ± 0.2
3.99 ± 0.2
9.82 ± 0.4
11.24 ± 0.4
13.28 ± 0.5.

The X-ray diffractogram of the crystalline k-phase contains the following X-ray diffraction pattern RMk, reproduced in the form of interplanar spacings d[Å] independent of the wavelength of the X-rays used

d[Å]
4.02 ± 0.2
3.16 ± 0.2
2.48 ± 0.2
2.01 ± 0.2
1.82 ± 0.1.

i-Phase and k-phase are similar to one another but differ especially in that the X-ray diffractogram of the k-phase usually has no reflections for d≧4.2 Å. Usually, the k-phase also comprises no reflections in the range from 3.8 Å≧d≧3.35 Å. Furthermore, the k-phase comprises as a rule no reflections in the range from 2.95 Å≧d≧2.68 Å.

Furthermore, it is known from the abovementioned prior art that the catalytic efficiency (activity, selectivity of formation of target product) of the multimetal oxide materials having an i-phase structure is as a rule superior to that in another (e.g. k-phase) structure.

However, from the abovementioned prior art it is also known that it is very difficult to produce multimetal oxide materials M in the i-phase structure.

Thus, as a rule, solid solution systems are obtained which have only a certain i-phase fraction (e.g. in addition to k-phase) and from which, from the point of view of optimum catalyst performance, the i-phase fraction is isolated by washing out the other phases (e.g. the k-phase) with suitable liquids (e.g. WO 02/06199, JP-A 7-232071, DE-A 102 54 279 and EP-A 1 407 819).

The preparation of multimetal oxide materials M of the general stoichiometry I is generally effected by a procedure in which an intimate dry blend is produced from starting compounds (sources) comprising their elemental constituents and said dry blend is subjected to a thermal treatment at an elevated temperature.

High i-phase fractions up to exclusive i-phase are obtainable as a rule when a mixture of sources of the elemental constituents of the multimetal oxide material M is subjected to a hydrothermal treatment and the new solid forming is separated off (cf. US-A 2003/0187299A1, DE-A 100 29 338, EP-A 1 270 068, EP-A 1 346 766 and EP-A 1 407 819).

According to the teaching of the prior art, suitable sources of the elemental constituents are more or less all possible compounds which comprises elemental constituents in chemically bound form.

A disadvantage of a hydrothermal method of preparation carried out in this manner is, however, that its reproducibility, in particular in the case of production of industrial amounts, is not completely satisfactory, i.e. the i-phase fraction resulting in the course of such a production fluctuates on repeated production within a comparatively wide range about an average value. Frequently, this average value is moreover at a comparatively low i-phase fraction. Moreover, the catalytic performance of the product directly obtainable hydrothermally is frequently unsatisfactory and as a rule necessitates a subsequent thermal treatment for improvement thereof.

The object of the present invention was therefore to provide a hydrothermal process for the preparation of multimetal oxide materials M of the general stoichiometry I, which process is improved with respect to the stated disadvantages.

Accordingly, a process for the preparation of a multimetal oxide material M of the general stoichiometry I
Mo₁VₐM¹_{b}M²_{c}M³_{d}M⁴ₑOₙ (I)
where
M¹=at least one of the elements from the group consisting of Al(+3), Ga(+3), In(+3), Ge(+4), Sn(+4), Pb(+4), As(+5), Bi(+5), Se(+6), Te(+6) and Sb(+5);
M²=at least one of the elements from the group consisting of Sc(+3), Y(+3), La(+3), Ti(+4), Zr(+4), Hf(+4), Nb(+5), Ta(+5+), Cr(+5), W(+6), Mn(+7), Fe(+3), Co(+3), Ni(+3), Zn(+2), Cd(+2) and the lanthanides (Ce(+4), Pr(+3), Nd(+3), Pm (+3), Sm(+3), Eu(+3), Gd(+3), Tb(+4), Dy(+3), Ho(+3), Er(+3), Tm(+3), Yb(+3) and Lu(+3));
M³=at least one of the elements from the group consisting of Re(+7), Ru(+8), Rh(+8), Pd(+8), Os(+8) Ir(+8+), Pt(+8), Cu(+2), Ag(+1) and Au(+1);
M⁴=at least one of the elements from the group consisting of Li(+1), Na(+1), K(+1), Rb(+1), Cs(+1), Be(+2), Mg(+2), Ca(+2), Ir(+2), Ba(+2), NH₄(+1) and TI(+1);
a=from 0.01 to 1 (preferably from 0.01 to 0.5);
b=from ≧0 to 1 (preferably from >0 to 0.5);
c=from ≧0 to 1 (preferably from >0 to 0.5);
d=from ≧0 to 0.5 (preferably from ≧0 to 0.1);
e=from ≧0 to 0.5 (preferably from ≧0 to 0.1 or 0) and
n=a number which is determined by the valency and frequency of the elements other than oxygen in (I),
   has been found, in which a mixture G of sources of the elemental constituents of the multimetal oxide material M is subjected to a hydrothermal treatment and the new solid forming is separated off, wherein exclusively sources from the group consisting of compounds which consist only of the elemental constituents of the multimetal oxide material M and of elemental constituents of water (O, H, OH), the elemental constituents of the multimetal oxide material M itself in their elemental form and ammonium salts comprising elemental constituents of the multimetal oxide material M (i.e. for example sources from the group consisting of oxides, hydrated oxides, oxygen acids, hydroxides, oxide hydroxides of the elemental constituents, the metal elements of the elemental constituents and compounds, such as ammonium metavanadate or ammonium heptamolybdate) are used as sources of the elemental constituents of the multimetal oxide material M, with the proviso that the molar ratio MR NH₄/Mo of NH₄ contained in the mixture G and Mo contained in the mixture G is ≦0.5 and at least a portion of the sources of the elemental constituents comprises the elemental constituents contained in these sources with an oxidation number which is below the maximum oxidation number of the respective elemental constituent (that is the number appearing in brackets after the individually listed elements M¹, M², M³ and M⁴ and having a positive sign).

It is preferred according to the invention if at least a portion of the sources (present in the mixture G) of the elemental constituent V comprises the vanadium having an oxidation number of <+5 (e.g. +4 or +3 or +2 or 0).

The hydrothermal preparation of multimetal oxide active materials is familiar to a person skilled in the art (cf. also, for example, Applied Catalysis A: 194 to 195 (2000) 479-485; Kinetics and Catalysis; Vol. 40, No. 3,1999, pp 401 to 404; Chem. Commun., 1999, 517 to 518; JP-A 6/227 819 and JP-A 2000/26123).

In this document, the procedure according to the invention is understood as meaning in particular the thermal treatment of a preferably intimate mixture G of sources of the elemental constituents of the desired multimetal oxide material M in a vessel under superatmospheric pressure (autoclave) in the presence of steam at superatmospheric pressure, usually at temperatures of from >100° C. to 600° C. The pressure range typically extends to (>1 bar) up to 500 bar, preferably up to 250 bar. According to the invention, temperatures above 600° C. and steam pressures above 500 bar can of course also be used, but this is less expedient in terms of application technology.

Particularly advantageously, the hydrothermal treatment according to the invention is effected under conditions under which steam and liquid aqueous phase coexist. This is possible in the temperature range from >100 to 374.15° C. (critical temperature of water) with the use of the corresponding pressures. The amounts of water are expediently such that the liquid aqueous phase is capable of taking up the total amount of the starting compounds of the elemental constituents in suspension and/or solution.

According to the invention, however, a hydrothermal procedure in which the preferably intimate mixture G of the starting compounds of the elemental constituents completely absorbs the amount of liquid water present in equilibrium with the steam is also possible.

According to the invention, the hydrothermal treatment according to the invention is advantageously effected at temperatures of from >100° C. to 300° C., preferably at temperatures of from 120° C. or from 150° C. to 250° C. (e.g. 160° C. to 180° C.).

Based on the sum of water and the mixture G (or those sources of the elemental constituents of the multimetal oxide material M which are contained therein), the proportion by weight of the latter in the autoclave is, according to the invention, as a rule at least 1% by weight. Usually, the abovementioned proportion by weight is not above 90% by weight. Preferably, the proportions by weight are from 5 to 60 or from 10 to 50% by weight, particularly preferably from 20 or from 30 to 50% by weight.

Apart from the sources, according to the invention, of the elemental constituents of the multimetal oxide material M and water, preferably no further substances are involved in the hydrothermal procedure according to the invention. The proportion by weight of such further substances should usually be ≦10% by weight, advantageously ≦5% by weight and even better ≦3% by weight, based on the mixture G. For example, all substances mentioned in DE-A 100 29 338 and in EP-A 1 407 819, but also H₂O₂ (taking into account the preferred redox conditions), are suitable as possible foreign substances of this type.

The hydrothermal treatment according to the invention can be carried out either with stirring (preferred) or without stirring.

Advantageously, the molar ratio MR is ≦0.3, particularly preferably ≦0.1 and very particularly preferably 0 in the process according to the invention.

Based on the total amount of those sources of the elemental constituent V which are contained in the mixture G and the total molar amount of V contained in these sources, preferably at least 5 mol % or at least 10 mol %, preferably at least 20 mol % or at least 30 mol %, very particularly preferably at least 40 mol % or at least 50 mol % and most preferably at least 60 mol % or at least 70 mol % or at least 80 mol % or at least 90 mol % or more (particularly advantageously the total amount) of the V contained in these sources in the process according to the invention are contained as vanadium whose oxidation number is <+5.

The arithmetic mean oxidation number of the V, averaged over the total molar amount of V of the vanadium sources contained in the mixture G, is preferably from +3.5 to +4.5, particularly preferably from +3.8 to +4.2 and very particularly preferably +4.

Very generally (particularly when the V is contained in its maximum oxidation number in at least a portion of its sources), the composition of the mixture G in the process according to the invention is preferably chosen with respect to the oxidation numbers of the elemental constituents contained in the sources for the mixture G so that, on changing all elemental constituents other than V (+5) which are not contained in their maximum oxidation number in the sources of the mixture G (including V (<+5)), to their respective maximum oxidation number (in the case of V, to its second highest oxidation number +4), the reduction potential available thereby is just sufficient to bring the average oxidation number of the V contained altogether in the sources of the mixture G to a value of from 3.5 to 4.5, particularly preferably from 3.8 to 4.2 and very particularly preferably 4.

If the hydrothermal treatment according to the invention is effected under an oxidizing atmosphere comprising molecular oxygen (e.g. under stationary, enclosed air), the abovementioned reduction potential may be correspondingly higher.

Overall, the conditions of the hydrothermal treatment according to the invention are preferably chosen so that the above reduction potential is actually implemented in the manner described during the hydrothermal treatment.

For the determination of the oxidation number of the V or of another elemental constituent within a source, the rules known per se, according to which the oxidation number of a certain element in a chemical compound is obtainable as follows, are applicable:
1. The oxidation number of an atom in a free element is zero.
2. The oxidation number of a single-atom ion is equal to its charge.
3. In a covalent compound of known structure, the oxidation number corresponds to the charge which each atom comprises if the bonding electron pairs are assigned completely to the more electronegative atom. In the case of electron pairs between two identical atoms, each atom receives one electron
   (cf. Grundlagen der aligemeinen und organischen Chemie [Principles of general and organic chemistry], Verlag Sauerländer, Aarau, Diesterweg Salle, Frankfurt am Main, 4th Edition, 1973).

Accordingly, suitable sources for the element V for the process according to the invention are in particular oxides of vanadium, such as VO₂, V₂O₃, V₆O₁₃, V₃O₇, V₄O₉ and VO, elemental vanadium and, taking into account the quantity limits according to the invention, also compounds such as V₂O₅ and ammonium metavanadate.

Sources for the element Mo which are suitable according to the invention are, for example, oxides of molybdenum, such as MoO₃ and MoO₂, elemental Mo and, taking into account the quantity limits according to the invention, also compounds such as ammonium heptamolybdate and the hydrates thereof.

According to the invention, suitable sources of the element tellurium are, for example, oxides of tellurium, such as TeO₂, metallic tellurium and also telluric acids, such as orthotelluric acid H₆TeO₆.

Antimony starting compounds which are advantageous according to the invention are, for example, oxides of antimony, such as Sb₂O₃, elemental Sb, and also antimonic acids, such as HSb(OH)₆.

Niobium sources suitable according to the invention are, for example, oxides of niobium, such as Nb₂O₅, or elemental Nb.

A bismuth source which is advantageous according to the invention is Bi₂O₃. An advantageous gold source is gold hydroxide. Further starting compounds advantageous for the process according to the invention are, for example, silver oxide, copper hydroxide, copper oxide, alkali metal and alkaline earth metal oxide and hydroxide, scandium oxide, iridium oxide, zinc oxide, Ga₂O, Ga₂O₃, etc. Of course, mixed oxides which comprise more than one elemental constituent and were obtained, if appropriate, by a hydrothermal method, for example by the hydrothermal method according to the invention, are also suitable as sources of the elemental constituents. Further sources of the elemental constituents which are suitable according to the invention are mentioned in the publications of the prior art cited.

The hydrothermal treatment according to the invention itself generally lasts for from a few minutes or hours to a few days. A period of 48 hours is typical. It is expedient in terms of application technology if the autoclave to be used for the hydrothermal treatment is coated on the inside with Teflon. Before the hydrothermal treatment, the autoclave, if appropriate including the aqueous mixture contained, can advantageously be evacuated. Thereafter, before the temperature is increased, said autoclave can preferably be filled with inert gas (N₂, noble gas, such as He, Ne and/or argon). Both measures can also be omitted, but this is less advantageous. For creating advantageous inert conditions, the aqueous mixture can of course additionally or alternatively be flushed with inert gas before the hydrothermal treatment according to the invention. The abovementioned inert gases can also be used, expediently in terms of application technology, for establishing superatmospheric pressure in the autoclave even before the hydrothermal treatment.

After the end of the hydrothermal treatment, the autoclave can either be quenched to room temperature or brought slowly to room temperature, i.e. over a relatively long period (for example by leaving it to stand).

An important aspect according to the invention is that the solid newly formed in the course of the hydrothermal treatment according to the invention and separated off after the end of the hydrothermal treatment is usually a multimetal oxide M having a high i-phase fraction or comprising exclusively i-phase and that, according to the invention, it is obtained with improved reproducibility.

Also important according to the invention is that the multimetal oxides M obtainable by the process according to the invention display the desired catalytic activity even without a thermal treatment following the hydrothermal treatment.

Of course, the multimetal oxides M obtainable according to the invention can advantageously be subjected to an additional thermal aftertreatment before they are used as active materials for the heterogeneously catalyzed process mentioned at the outset. This thermal aftertreatment can be carried out at temperatures of from 200 to 1200° C., preferably from 350 to 700° C., frequently from 400 to 650° C. and often from 400 to 600° C.

It can in principle be effected under an oxidizing, reducing or inert (preferred according to the invention) atmosphere. A suitable oxidizing atmosphere is, for example, air, air enriched with molecular oxygen or air depleted in oxygen.

The thermal treatment is preferably carried out under an inert atmosphere, i.e. for example under molecular nitrogen and/or noble gas (He, Ar and/or Ne) (in this document, inert atmosphere always means that the content of molecular oxygen is then usually ≦5% by volume, preferably ≦3% by volume, particularly preferably ≦1% by volume or ≦0.1% by volume and most preferably 0% by volume). Of course, the thermal aftertreatment can also be effected under reduced pressure.

Overall, the thermal aftertreatment may take up to 24 hours or more. A thermal aftertreatment is preferably first effected under an oxidizing (oxygen-containing atmosphere) (e.g. under air) at a temperature of from 150° C. to 400° C. or from 250° C. to 350° C. Thereafter, the thermal aftertreatment is expediently continued under inert gas at temperatures of from 350° C. to 700° C. or from 400° C. to 650° C. or from 400° C. to 600° C. Of course, the thermal aftertreatment of the hydrothermally produced multimetal oxide M can also be effected in such a way that the hydrothermally produced multimetal oxide M is first pelleted, then subjected to the thermal aftertreatment and subsequently converted into chips.

It is expedient in terms of application technology if the multimetal oxide M obtainable in the course of the hydrothermal process according to the invention is, however, converted into chips for its thermal aftertreatment.

Furthermore, both the multimetal oxide materials M obtainable according to the invention by a hydrothermal method and their subsequent or successor multimetal oxide materials thermally aftertreated as described can be further treated in an advantageous manner by washing them with suitable liquids, as described, for example, in DE-A 102 54 279 and EP-A 1 407 819. Suitable such liquids are, for example, organic acids and the aqueous solutions thereof (e.g. oxalic acid, formic acid, acetic acid, citric acid and tartaric acid) and inorganic acids and the aqueous solutions thereof (e.g. sulfuric acid, perchloric acid, hydrochloric acid, nitric acid, boric acid and/or telluric acid), but also alcohols, alcoholic solutions of the abovementioned acids or hydrogen peroxide and the aqueous solutions thereof. Of course, mixtures of the abovementioned washing liquids can also be used for washing. Furthermore, JP-A 7-232 071 or DE-A 103 21 398 also discloses a suitable washing method. In the course of such washing, pure i-phase (or an increased i-phase fraction) usually remains and, in the washed state, usually also has an additionally improved catalyst performance.

The intimate mixing of the starting compounds of the elemental constituents to give the mixture G to be hydrothermally treated can be effected in dry or in wet form. If it is effected in dry form, the starting compounds are expediently used in the form of finely divided powders. The intimate mixing is, however, preferably effected in wet, aqueous form. The starting compounds are preferably mixed with one another in the form of an aqueous solution (if appropriate, with the concomitant use of small amounts of complexing agents) and/or finely divided suspension.

Over and above the reflections already mentioned at the outset, the X-ray diffraction pattern RMi of the multimetal oxide materials M obtainable hydrothermally according to the invention or their subsequent materials obtainable by thermal aftertreatment and/or by washing to be carried out as described (or successor materials) often has (depending on the elements contained and the crystal geometry (e.g. acicular form or tabular form)) additional characteristic reflection intensities.

Based on the intensity of the reflection representing the interplanar spacing d[Å]=3.99±0.2, these (relative) reflection intensities I (%) are as follows:

| d[Å] | I (%) |
|---|---|
| 3.06 ± 0.2 (preferably ± 0.1) | 5 to 65 |
| 3.17 ± 0.2 (preferably ± 0.1) | 5 to 65 |
| 3.28 ± 0.2 (preferably ± 0.1) | 15 to 130, frequently 15 to 95 |
| 3.99 ± 0.2 (preferably ± 0.1) | 100 |
| 9.82 ± 0.4 (preferably ± 0.2) | 1 to 50, frequently 1 to 30 |
| 11.24 ± 0.4 (preferably ± 0.2) | 1 to 45, frequently 1 to 30 |
| 13.28 ± 0.5 (preferably ± 0.3) | 1 to 35, frequently 1 to 15. |

In addition to the abovementioned, particularly characteristic reflections, the following reflections, likewise reproduced in the form of interplanar spacings d[Å] independent of the wavelength of the X-rays used, are also often detectable in the abovementioned X-ray diffraction pattern RMi:

d[Å]

8.19 ± 0.3 (preferably ± 0.15)
3.51 ± 0.2 (preferably ± 0.1)
3.42 ± 0.2 (preferably ± 0.1)
3.34 ± 0.2 (preferably ± 0.1)
2.94 ± 0.2 (preferably ± 0.1)
2.86 ± 0.2 (preferably ± 0.1).

Based on the intensity of the reflection representing the interplanar spacing d[Å]=3.99±0.2, the (relative) intensities I (%) of the above reflections are frequently as follows:

| d[Å] | I (%) |
|---|---|
| 8.19 ± 0.3 (or ± 0.15) | 0 to 25 |
| 3.51 ± 0.2 (or ± 0.1) | 2 to 50 |
| 3.42 ± 0.2 (or ± 0.1) | 5 to 75 |
| 3.34 ± 0.2 (or ± 0.1) | 5 to 80 |
| 2.94 ± 0.2 (or ± 0.1) | 5 to 55 |
| 2.86 ± 0.2 (or ± 0.1) | 5 to 60. |

Often, the following reflections also supplement the abovementioned X-ray diffraction pattern RMi:

d[Å]

2.54 ± 0.2 (preferably ± 0.1)
2.01 ± 0.2 (preferably ± 0.1).

In the case of these reflections, the (relative) reflection intensities having the same basis as above are often as follows:

| d[Å] | I (%) |
|---|---|
| 2.54 ± 0.2 (or ±0.1) | 0.5 to 40 |
| 2.01 ± 0.2 (or ±0.1) | 5 to 60. |

According to the invention, the X-ray diffraction patterns which are preferred among the abovementioned X-ray diffraction patterns RMi (or the multimetal oxide materials or their successor materials associated with said patterns) are those in which the reflection representing the interplanar spacing d[Å]=3.99±0.2 (or ±0.1) or that representing the interplanar spacing d[Å]=3.28±0.2 (or ±0.1) is the most intense reflection (that having the strongest intensity).

Furthermore, preferred X-ray diffraction pattems RMi (or the multimetal oxide materials or the successor materials thereof which are associated with said pattems) are those in which the 2θ full width at half height of the reflection d[Å]=3.99±0.2 (or ±0.1) is ≦1°, preferably ≦0.5°. The 2θ full width at half height of the other reflections mentioned is usually ≦3°, preferably ≦1.5°, particularly preferably ≦1°.

All data in this document which relate to an X-ray diffractogram are based on an X-ray diffractogram produced using CuKa radiation (λ=1.54178 Å) as X-rays (Siemens diffractometer Theta-Theta D-5000, tube voltage: 40 kV, tube current: 40 mA, aperture V20 (variable), collimator V20 (variable), secondary monochromator aperture (0.1 mm), detector aperture (0.6 mm), measuring interval (2θ): 0.02°, measuring time per step: 2.4 s, detector scintillation counter; in this document, the definition of the intensity of a reflection in the X-ray diffractogram is based on the definition stated in DE-A 198 35 247, DE-A 101 22 027 and in DE-A 100 51 419 and DE-A 100 46 672, which are hereby incorporated by reference in this Application; the same applies to the definition of the 2θ full width at half height).

The wavelength λ of the X-rays used for the diffraction and the diffraction angle θ (in this document, the summit of a reflection in the 2θ plot is used as the position of the reflection) are linked with one another via Bragg's relationship, as follows:
2 sin θ=λ/d,
where d is the interplanar spacing of the three-dimensional atomic arrangement, associated with the respective reflection.

Preferred multimetal oxide materials M of the general stoichiometry I which are obtainable according to the invention (and the successor materials associated with them) are those in which the following is applicable:
M¹=at least one of the elements from the group consisting of Sb, Bi, Se and Te;
M²=at least one of the elements from the group consisting of Ti, Zr, Nb, Cr, W, Fe, Co, Ni and Zn;
M³=at least one of the elements from the group consisting of Re, Pd and Pt;
M⁴=at least one of the elements from the group consisting of Rb, Cs, Sr and Ba;
a=from 0.01 to 1 (preferably from 0.01 to 0.5);
b=from ≧0 to 1 (preferably from >0 to 0.5);
c=from ≧0 to 1 (preferably from >0 to 0.5);
d=from ≧0 to 0.5 (preferably from ≧0 to 0.1);
e=from ≧0 to 0.5 (preferably from ≧0 to 0.1 or 0) and
n=a number which is determined by the valency and frequency of the elements other than oxygen in (I).

It is preferred according to the invention if the stoichiometric coefficient a of the multimetal oxide materials M obtainable according to the invention (and of the successor materials associated with them) is from 0.05 to 0.5, particularly preferably from 0.1 to 0.5, independently of the preferred ranges for the other stoichiometric coefficients of the multimetal oxide materials M and of the chosen elemental composition.

The stoichiometric coefficient b is preferably from >0 or 0.01 to 0.5, and particularly preferably from 0.1 to 0.5 or to 0.4, independently of the preferred ranges for the other stoichiometric coefficients of the multimetal oxide materials M and of the chosen elemental composition.

The stoichiometric coefficient c of the multimetal oxide materials M obtainable according to the invention is advantageously from 0.01 to 0.5 and particularly preferably from 0.1 to 0.5 or to 0.4, independently of the preferred ranges for the other stoichiometric coefficients of the multimetal oxide materials M and of the chosen elemental composition. A very particularly preferred range for the stoichiometric coefficient c which, independently of the preferred ranges for the other stoichiometric coefficients of the multimetal oxide materials M obtainable according to the invention, can be combined with all other preferred ranges in this document and all chosen elemental compositions, is the range from 0.05 to 0.2.

The stoichiometric coefficient d of the multimetal oxide materials M obtainable according to the invention is preferably from ≧0 or 0.00005 or 0.0005 to 0.5, particularly preferably from 0.001 to 0.5, frequently from 0.002 to 0.3 and often from 0.005 or 0.01 to 0.1, independently of the preferred ranges for the other stoichiometric coefficients of the multimetal oxide materials M and of the chosen elemental composition.

The coefficient e may also be from ≧0 to 0.1 and advantageously 0, independently of the preferred ranges for the other stoichiometric coefficients of the multimetal oxide materials M and of the chosen elemental composition.

Multimetal oxide materials M which are obtainable according to the invention and whose stoichiometric coefficients a, b, c and d are simultaneously within the following ranges are particularly advantageous:
a=from 0.05 to 0.5;
b=from 0.01 to 1 (or from 0.01 to 0.5);
c=from 0.01 to 1 (or from 0.01 to 0.5);
d=from 0.0005 to 0.5; and
e=from ≧0 to 0.5.

Multimetal oxide materials M which are obtainable according to the invention and whose stoichiometric coefficients a, b, c and d are simultaneously within the following ranges are very particularly advantageous:
a=from 0.1 to 0.5;
b=from 0.1 to 0.5;
c=from 0.1 to 0.5;
d=from 0.001 to 0.5 or from 0.001 to 0.3 or from 0.001 to 0.1; and
e=from ≧0 to 0.2 or to 0.1.
M¹ is preferably Bi, Se, Te and/or Sb and very particularly preferably Te.

All of the abovementioned applies in particular when at least 50 mol % of the total amount of M² is Nb, Ti, Zr, Cr, W, Fe, Co, Ni, Zn and/or Ta and very particularly preferably when at least 50 mol % or at least 75 mol % of the total amount of M² or 100 mol % of the total amount of M² is Nb and at least one of the elements is Ti, Zr, Cr, Ta, W, Fe, Co, Ni and Zn or Nb and/or Ta.

However, it also applies in particular, independently of the meaning M², when M³ is at least one element from the group consisting of Re, Pd and Pt.

However, all of the abovementioned also applies in particular when at least 50 mol % of the total amount of M², or at least 75 mol % or 100 mol %, is Nb and M³ is at least one element from the group consisting of Re, Pd and Pt.

However, all of the abovementioned also applies in particular when at least 50 mol % or at least 75 mol % or 100 mol % of the total amount of M² is Nb and at least one of the elements is Co, Ni, Ta, W, Fe and M³ is at least one element from the group consisting of Re, Pd and Pt.

Very particularly preferably, all statements regarding the stoichiometric coefficients apply when M¹ is Te, M² is Nb and at least one of the elements is Ni, Co, Fe and M³ is at least one element from the group consisting of Pd, Re and Pt.

Advantageous multimetal oxide materials M obtainable according to the invention are those (and particularly all abovementioned ones) with e=0. If e>0, M⁴ is preferably Cs.

Further stoichiometries I suitable according to the invention are those in this document which are disclosed for the multimetal oxide materials of the stoichiometry (I) in the prior art cited.

The multimetal oxide materials M of the general stoichiometry I which are obtainable according to the invention by the hydrothermal method as described, or the subsequent materials of these multimetal oxide materials (as a rule, they likewise have the stoichiometry I) can be used as such (i.e. as a powder or as chips) or after shaping into moldings as catalytic active materials for all partial gas-phase oxidations and/or ammoxidations of, for example, saturated and unsaturated hydrocarbons or lower aldehydes and/or alcohols, which oxidations and ammoxidations are described in the introduction of this document The catalyst bed may be a fixed bed, a moving bed or a fluidized bed. The shaping can be effected, for example, by extrusion or pelleting in the case of unsupported catalysts or by application to a support (preparation of coated catalysts), as described in DE-A 10118814 or PCT/EP/02/04073 or DE-A 10051419.

The supports to be used in the case of coated catalysts for the multimetal oxide materials M obtainable according to the invention and the successor materials thereof are preferably chemically inert, i.e. they substantially do not intervene in the course of the partial catalytic gas-phase oxidation or ammoxidation of the hydrocarbon (e.g. propane and/or propene to acrylic acid), alcohol or aldehyde, which is catalyzed by the multimetal oxide materials M obtainable according to the invention and the successor materials thereof.

According to the invention, suitable materials for the supports are in particular alumina, silica, silicates, such as clay, kaolin, steatite (preferably steatite from CeramTec (Germany) of the type C-220, or preferably having a low water-soluble alkali content), pumice, aluminum silicate and magnesium silicate, silicon carbide, zirconium dioxide and thorium dioxide.

The surface of the support may be either smooth or rough. Advantageously, the surface of the support is rough since increased surface roughness generally results in greater adhesive strength of the applied active material coat.

Frequently, the surface roughness R₂ of the support is in the range from 5 to 200 μm, often in the range from 20 to 100 μm (determined according to DIN 4768, Sheet 1, using a “Hommel Tester for DIN-ISO surface parameters” from Hommelwerke, Germany).

Furthermore, the support material may be porous or nonporous. Expediently, the support material is nonporous (total volume of the pores ≦1% by volume, based on the volume of the support).

The thickness of the active oxide material coat present in the coated catalysts according to the invention is usually from 10 to 1000 μm. However, it may also be from 50 to 700 μm, from 100 to 600 μm or from 150 to 400 μm. Other possible coat thicknesses are from 10 to 500 μm, from 100 to 500 μm or from 150 to 300 μm.

In principle, any desired geometries of the supports are suitable for the process according to the invention. Their longest dimension is as a rule from 1 to 10 mm. However, spheres or cylinders, in particular hollow cylinders, are preferably used as supports. Advantageous diameters for spherical supports are from 1.5 to 4 mm. If cylinders are used as supports, their length is preferably from 2 to 10 mm and their external diameter is preferably from 4 to 10 mm. In the case of rings, the wall thickness is moreover usually from 1 to 4 mm. Annular supports suitable according to the invention may also have a length of from 3 to 6 mm, an external diameter of from 4 to 8 mm and a wall thickness of from 1 to 2 mm. However, annular supports may also measure 7 mm×3 mm×4 mm or 5 mm×3 mm×2 mm (external diameter×length×internal diameter).

The preparation of the coated catalysts can be most easily effected by preforming according to the invention multimetal oxide materials M or the subsequent material thereof, converting them into finely divided form and finally applying them to the surface of the support with the aid of a liquid binder. For this purpose, the surface of the support is most simply moistened with the liquid binder and a coat of the active material is caused to adhere to the moistened surface by bringing into contact with finely divided active multimetal oxide material M obtained according to the invention or finely divided subsequent material. Finally, the coated support is dried. The process can of course be repeated periodically for achieving a greater coat thickness. In this case, the coated base body becomes the new “support”, etc.

The fineness of the catalytically active multimetal oxide material M of the general formula (I) to be applied to the surface of the support, or of the successor material thereof, is of course adapted to the desired coat thickness. For the coat thickness range from 100 to 500 μm, for example, those active material powders of which at least 50% of the total number of powder particles pass through a sieve of mesh size from 1 to 20 μm and whose numerical fraction of particles having a longest dimension above 50 μm is less than 10% are suitable. As a rule, the distribution of the longest dimensions of the powder particles corresponds to a Gaussian distribution as a result of the production. Frequently, the particle size distribution is as follows:

| D (μm) | 1 | 1.5 | 2 | 3 | 4 | 6 | 8 | 12 | 16 | 24 | 32 | 48 | 64 | 96 | 128 |
|---|---|---|---|---|---|---|---|---|---|---|---|---|---|---|---|
| x | 80.5 | 76.3 | 67.1 | 53.4 | 41.6 | 31.7 | 23 | 13.1 | 10.8 | 7.7 | 4 | 2.1 | 2 | 0 | 0 |
| y | 19.5 | 23.7 | 32.9 | 46.6 | 58.4 | 68.3 | 77 | 86.9 | 89.2 | 92.3 | 96 | 97.9 | 98 | 100 | 100 |

Here:
D=diameter of the particle;
x=percentage of particles whose diameter is ≧D; and
y=percentage of particles whose diameter is <D.

For carrying out the coating process described on an industrial scale, it is advisable, for example, to use the process principle disclosed in DE-A 2909671 and that disclosed in DE-A 10051419, i.e. the supports to be coated are initially taken in a rotating container (e.g. rotating pan or coating drum) which is preferably inclined (the angle of inclination is as a rule ≧0° and ≦90°, generally ≧30° and ≦90°; the angle of inclination is the angle between the central axis of the rotating container and the horizontal). The rotating container transports the supports, which, for example, are spherical or cylindrical, under two metering apparatuses arranged a certain distance in succession. The first of the two metering apparatuses expediently corresponds to a nozzle (for example, an atomizer nozzle operated with compressed air), by means of which the supports rolling in the rotating pan are sprayed with the liquid binder and moistened in a controlled manner. The second metering apparatus is present outside the atomization cone of the liquid binder sprayed in and serves for feeding in the finely divided oxidic active material (for example, via a shaking trough or a powder screw). The spherical supports moistened in a controlled manner take up the supplied active material powder, which becomes compacted by the rolling movement on the outer surface of the support, which, for example, is cylindrical or spherical, to give a cohesive coat.

If required, the support provided in this manner with a base coat again passes through the spray nozzles in the course of the subsequent revolution, is moistened thereby in a controlled manner and is thus able to take up a further coat of finely divided oxidic active material in the course of the further movement, etc. (intermediate drying is as a rule not necessary). Finely divided oxidic active material and liquid binder are as a rule fed in continuously and simultaneously.

After the end of coating, the liquid binder can be removed, for example, by the action of hot gases, such as N₂ or air. Remarkably, the coating process described results in completely satisfactory adhesion of both the successive coats to one another and of the base coat to the surface of the support.

An important aspect of the coating method described above is that the moistening of the support surface to be coated is carried out in a controlled manner. In short, this means that the support surface is expediently moistened in such a way that it has adsorbed liquid binder but no liquid phase as such is visible on the support surface. If the support surface is too moist, the finely divided catalytically active oxide material agglomerates to form separate agglomerates instead of being adsorbed onto the surface. Detailed information in this context is to be found in DE-A 2909671 and in DE-A 10051419.

The abovementioned final removal of the liquid binder used can be carried out in a controlled manner, for example by evaporation and/or sublimation. In the simplest case, this can be effected by the action of hot gases of corresponding temperature (frequently from 50 to 300° C., often 150° C.). However, only preliminary drying can be effected by the action of hot gases. The final drying can then be effected, for example, in a drying oven of any type (e.g. belt dryer) or in the reactor. The applied temperature should not be above the calcination temperature used for the preparation of the oxidic active material. The drying can of course also be carried out exclusively in a drying oven.

The following may be used as binders for the coating process, independently of the type and of the geometry of the support: water, monohydric alcohols, such as ethanol, methanol, propanol and butanol, polyhydric alcohols, such as ethylene glycol, 1,4-butanediol, 1,6-hexanediol or glycerol, monobasic or polybasic organic carboxylic acids, such as propionic acid, oxalic acid, malonic acid, glutaric acid or maleic acid, amino alcohols, such as ethanolamine or diethanolamine, and monofunctional or polyfunctional organic amides, such as formamide. Advantageous binders are also solutions consisting of from 20 to 90% by weight of water and from 10 to 80% by weight of an organic compound which is dissolved in water and whose boiling point or sublimation temperature at atmospheric pressure (1 atm) is >100° C., preferably >150° C. Advantageously, the organic compound is selected from the above list of possible organic binders. Preferably, the organic fraction of abovementioned aqueous binder solutions is from 10 to 50 and particularly preferably from 20 to 30% by weight. Suitable organic components thereby are also monosaccharides and oligosaccharides, such as glucose, fructose, sucrose or lactose, and polyethylene oxides and polyacrylates.

Suitable geometries (both for unsupported catalysts and for coated catalysts) are spheres, solid cylinders and hollow cylinders (rings). The longest dimension of the abovementioned geometries is as a rule from 1 to 10 mm. In the case of cylinders, their length is preferably from 2 to 10 mm and their external diameter preferably from 4 to 10 mm. In the case of rings, the wall thickness is moreover usually from 1 to 4 mm. Suitable annular unsupported catalysts may also have a length from 3 to 6 mm, an external diameter of from 4 to 8 mm and a wall thickness of from 1 to 2 mm. However, an annular unsupported catalyst measuring 7 mm×3 mm×4 mm or measuring 5 mm×3 mm×2 mm (external diameter×length×internal diameter) is also possible. Suitable geometries of the multimetal oxide active materials M obtainable according to the invention and their successor materials are of course also all those in DE-A 101 01 695.

The specific surface area of multimetal oxide materials M obtainable according to the invention (and their successor materials) is often from 1 to 80 m²/g or to 40 m²/g, often from 11 or 12 to 40 m²/g and frequently from 15 or 20 to 40 or 30 m²/g (determined by the BET method, nitrogen).

Otherwise, the statements made in DE-A 103 03 526 are applicable for the multimetal oxide materials M obtainable according to the invention and their successor materials.

This means that the multimetal oxide materials M obtainable according to the invention and their successor materials can of course also be used as catalytic active materials in a form diluted with finely divided, e.g. colloidal, materials having substantially only a diluent effect, such as silica, titanium dioxide, alumina, zirconium oxide and niobium oxide.

The dilution mass ratio may be up to 9 (diluent): 1 (active material), i.e. possible dilution mass ratios are, for example, 6 (diluent): 1 (active material) and 3 (diluent): 1 (active material). Incorporation of the diluents can be effected before and/or after a thermal aftertreatment.

The multimetal oxide materials M obtainable according to the invention and their successor materials are suitable as such or in a form diluted as described above (as already stated) as active materials for heterogeneously catalyzed partial gas-phase oxidations (including oxydehydrogenations) and/or ammoxidations of saturated and/or unsaturated hydrocarbons and of alcohols and aldehydes (for example, in a process according to DE-A 103 16 465).

Such saturated and/or unsaturated hydrocarbons are in particular ethane, ethylene, propane, propylene, n-butane, isobutane and isobutene. Target products thereby are in particular acrolein, acrylic acid, methacrolein, methacrylic acid, acrylonitrile and methacrylonitrile. However, they are also suitable for the heterogeneously catalyzed partial gas-phase oxidation and/or ammoxidation of compounds such as acrolein and methacrolein.

However, ethylene, propylene and acetic acid can also be a target product.

In this document, a complete oxidation of a hydrocarbon, alcohol and/or aldehyde is understood as meaning that all the carbon contained in the hydrocarbon, alcohol and/or aldehyde is converted into oxides of carbon (CO, CO₂).

All other reactions of the hydrocarbon with participation of molecular oxygen in the reaction are subsumed in this document under the term partial oxidation. The additional participation of ammonia in the reaction characterizes partial ammoxidation.

The multimetal oxide materials M obtainable according to this document and their successor materials are preferably suitable as catalytic active materials for the conversion of propane to acrolein and/or acrylic acid, of propane to acrylic acid and/or acrylonitrile, of propylene to acrolein and/or acrylic acid, of propylene to acrylonitrile, of isobutane to methacrolein and/or methacrylic acid, of isobutane to methacrylic acid and/or methacrylonitrile, of ethane to ethylene, of ethane to acetic acid and of ethylene to acetic acid.

The procedure for such partial oxidations and/or ammoxidations (by the choice of the ammonia content in the reaction gas mixture, to be controlled in a manner known per se, the reaction can be designed substantially exclusively as a partial oxidation or exclusively as a partial ammoxidation or as a superposition of the two reactions; cf. for example WO 98/22421) is known per se from the multimetal oxide materials of the general stoichiometry I of the prior art and can be carried out in a completely corresponding manner.

If the hydrocarbon used is crude propane or crude propylene, this preferably has the composition as described in DE-A 102 46 119 or DE-A 101 18 814 or PCT/EP/02/04073. The procedure, too, is preferably as described there.

A partial oxidation of propane to acrylic acid, to be carried out using catalysts comprising multimetal oxide M active material (or successor active material), can be carried out, for example, as described in EP-A 608 838, EP-A 1 407 819, WO 00/29106, JP-A 10-36311 and EP-A 1 192 987.

For example, air, air enriched with oxygen or air depleted in oxygen or pure oxygen can be used as a source of the required molecular oxygen.

Such a process is advantageous even when the reaction gas starting mixture contains no noble gas, in particular no helium, as inert diluent gas. Otherwise, the reaction gas starting mixture can of course comprise inert diluent gases, e.g. N₂, CO and CO₂, in addition to propane and molecular oxygen. Steam as a component of the reaction gas mixture is advantageous according to the invention.

This means that the reaction gas starting mixture with which the multimetal oxide active material M obtainable according to the invention or the successor material thereof is to be loaded at reaction temperatures of, for example, from 200 to 550° C. or from 230 to 480° C. or from 300 to 440° C. and pressures of from 1 to 10 bar or from 2 to 5 bar, may have, for example, the following composition:
from 1 to 15, preferably from 1 to 7, % by volume of propane,
from 44 to 99% by volume of air and
from 0 to 55% by volume of steam.

Steam-comprising reaction gas starting mixtures are preferred.

The following are suitable as other possible compositions of the reaction gas starting mixture:
from 70 to 95% by volume of propane,
from 5 to 30% by volume of molecular oxygen and
from 0 to 25% by volume of steam.

A product gas mixture which does not consist exclusively of acrylic acid is of course obtained in such a process. Rather, in addition to unconverted propane, the product gas mixture comprises secondary components, such as propene, acrolein, CO₂, CO, H₂O, acetic acid, propionic acid, etc., of which the acrylic acid has to be separated off.

This can be effected in the manner known from the heterogeneously catalyzed gas-phase oxidation of propene to acrylic acid.

This means that the acrylic acid contained can be taken up from the product gas mixture by absorption with water or by absorption with a high-boiling inert hydrophobic organic solvent (for example a mixture of diphenyl ether and diphyl, which, if appropriate, may also contain additives, such as dimethyl phthalate). The resulting mixture of absorbent and acrylic acid can then be worked up by rectification, extraction and/or crystallization in a manner known per se to give pure acrylic acid. Alternatively, the initial isolation of the acrylic acid from the product gas mixture can also be effected by fractional condensation, as described, for example, in DE-A 19 924 532.

The resulting aqueous acrylic acid condensate can then be further purified, for example, by fractional crystallization (for example, suspension crystallization and/or layer crystallization).

The residual gas mixture remaining in the initial isolation of the acrylic acid contains in particular unconverted propane, which is preferably recycled to the gas-phase oxidation. For this purpose, it can be partly or completely separated from the residual gas mixture, for example by fractional rectification under pressure, and then recycled to the gas-phase oxidation. However, it is more advantageous to bring the residual gas into contact with a hydrophobic organic solvent in an extraction apparatus (for example by passing said gas through) which is capable of preferentially absorbing the propane.

By subsequent desorption and/or stripping with air, the absorbed propane can be liberated again and can be recycled to the process according to the invention. In this way, economic overall propane conversions are achievable. As in other separation methods, too, propene formed as a secondary component is as a rule not separated, or not completely separated, from the propane and is circulated therewith. This also applies in the case of other homologous saturated and olefinic hydrocarbons. In particular, it is true very generally for heterogeneously catalyzed partial oxidations and/or ammoxidations, according to the invention, of saturated hydrocarbons.

It is found to be advantageous that the multimetal oxide materials M obtainable according to the invention and their successor materials are also capable of heterogeneously catalyzing the partial oxidation and/or ammoxidation of the homologous olefinic hydrocarbon to the same target product. Thus, using the multimetal oxide materials M obtainable according to the invention and their successor materials as active materials, acrylic acid can be prepared by heterogeneously catalyzed partial gas-phase oxidation of propene as molecular oxygen, as described in DE-A 101 18 814 or PCT/EP/02/04073 or JP-A 7-53448.

This means that a single reaction zone A is sufficient for carrying out the process. In this reaction zone, exclusively catalysts comprising multimetal oxide material M obtainable according to the invention or comprising successor material are present as catalytically active materials.

This is unusual since the heterogeneously catalyzed gas-phase oxidation of propene to acrylic acid takes place very generally in two steps at successive times. In the first step, usually propene is oxidized substantially to acrolein and, in the second step, usually acrolein formed in the first step is oxidized to acrylic acid.

Conventional processes for the heterogeneously catalyzed gas-phase oxidation of propene to acrylic acid therefore usually use a special catalyst type tailored to the oxidation step for each of the two abovementioned oxidation steps.

This means that the conventional processes for the heterogeneously catalyzed gas-phase oxidation of propene to acrylic acid operate with two reaction zones, in contrast to the process according to the invention.

In the process for the partial oxidation of propene, it is of course possible for only one or more than one catalyst comprising multimetal oxide material M obtainable according to the invention or comprising successor material to be present in the one reaction zone A. Of course, the catalysts to be used may be diluted with inert material, as also recommended, for example, as support material in this document.

In the process for the partial oxidation of propene, it is possible for only one temperature, or one temperature changing along the reaction zone A, of a heating medium for heating the reaction zone A to prevail along the one reaction zone A. This temperature change may be incremental or decremental.

If the propene partial oxidation process according to the invention is carried out as a fixed-bed oxidation, it is expediently effected in a tube-bundle reactor whose catalyst tubes are loaded with the catalyst. Usually, a liquid, as a rule a salt bath, is passed as a heating medium around the catalyst tubes.

A plurality of temperature zones along the reaction zone A can then be realized in a simple manner by passing more than one salt bath around the catalyst tubes section-by-section along the catalyst tubes.

Considered over the reactor, the reaction gas mixture is passed in the catalyst tubes either cocurrently or countercurrently to the salt bath. The salt bath itself can execute a purely parallel flow relative to the catalyst tubes. Of course, a transverse flow may also be superposed on this. Overall, the salt bath may also execute a meandering flow around the catalyst tubes, which, only considered over the reactor, is cocurrent or countercurrent to the reaction gas mixture.

In the propene partial oxidation process, the reaction temperature along the entire reaction zone A may be from 200 to 500° C. Usually, it is from 250 to 450° C. The reaction temperature is preferably from 330 to 420° C., particularly preferably from 350 to 400° C.

In the propene partial oxidation process, the operating pressure may be 1 bar, less than 1 bar or more than 1 bar. According to the invention, typical operating pressures are from 1.5 to 10 bar, frequently from 1.5 to 5 bar. The propene to be used for the propene partial oxidation process does not have to meet any particularly high requirements with respect to its purity.

As already stated and as is very general for all one-stage or two-stage processes for the heterogeneously catalyzed gas-phase oxidation of propene to acrolein and/or acrylic acid, for example, propene (also referred to as crude propene) having the following two specifications can be used entirely without problems as propene for such a process:

a) Polymer grade propylene:

| | | |
|---|---|---|
| ≧99.6% | by weight | propene, |
| ≦0.4% | by weight | propane, |
| ≦300 | ppm by weight | ethane and/or methane, |
| ≦5 | ppm by weight | C₄-hydrocarbons, |
| ≦1 | ppm by weight | acetylene, |
| ≦7 | ppm by weight | ethylene, |
| ≦5 | ppm by weight | water, |
| ≦2 | ppm by weight | O₂, |
| ≦2 | ppm by weight | sulfur-containing compounds |
| | | (calculated as sulfur), |
| ≦1 | ppm by weight | chlorine-containing compounds |
| | | (calculated as chlorine), |
| ≦5 | ppm by weight | CO₂, |
| ≦5 | ppm by weight | CO, |
| ≦10 | ppm by weight | cyclopropane, |
| ≦5 | ppm by weight | propadiene and/or propyne, |
| ≦10 | ppm by weight | C_{≧5}-hydrocarbons and |
| ≦10 | ppm by weight | carbonyl-containing compounds |
| | | (calculated as Ni(CO)₄). |

b) Chemical grade propylene:

| | | |
|---|---|---|
| ≧94% | by weight | propene, |
| ≦6% | by weight | propane, |
| ≦0.2% | by weight | methane and/or ethane, |
| ≦5 | ppm by weight | ethylene, |
| ≦1 | ppm by weight | acetylene, |
| ≦20 | ppm by weight | propadiene and/or propyne, |
| ≦100 | ppm by weight | cyclopropane, |
| ≦50 | ppm by weight | butene, |
| ≦50 | ppm by weight | butadiene, |
| ≦200 | ppm by weight | C₄-hydrocarbons, |
| ≦10 | ppm by weight | C_{≧5}-hydrocarbons, |
| ≦2 | ppm by weight | sulfur-containing compounds |
| | | (calculated as sulfur), |
| ≦0.1 | ppm by weight | sulfides (calculated as H₂S), |
| ≦1 | ppm by weight | chlorine-containing compounds |
| | | (calculated as chlorine), |
| ≦0.1 | ppm by weight | chlorides (calculated as Cl^{θ}) and |
| ≦30 | ppm by weight | water. |

However, all abovementioned possible impurities of the propene can of course also each be contained in twice to ten times the stated individual amount in the crude propene without the usability of the crude propene for the process or for the known processes for the one-stage or two-stage heterogeneously catalyzed gas-phase oxidation of propene to acrolein and/or acrylic acid very generally being adversely affected.

This applies in particular if, as in the case of the saturated hydrocarbons, the steam, the oxides of carbon and the molecular oxygen, they are in any case compounds which participate in the reaction either as inert diluent gases or as reactants in large amounts in the abovementioned processes. Usually, the crude propene as such is used as a mixture with recycle gas, air and/or molecular oxygen and/or dilute air and/or inert gas for the process for the heterogeneously catalyzed gas-phase oxidation of propene to acrolein and/or acrylic acid.

However, another suitable propene source for the process according to the invention is propene which is formed as a byproduct in the course of a process differing from the process according to the invention and contains, for example, up to 40% by weight of propane. This propene may additionally be accompanied by other impurities which do not substantially interfere with the process according to the invention.

Both pure oxygen and air or air enriched with oxygen or air depleted in oxygen may be used as an oxygen source for the propene partial oxidation process.

In addition to molecular oxygen and propene, a reaction gas starting mixture which is to be used for the propene partial oxidation process usually also contains at least one diluent gas. Nitrogen, oxides of carbon, noble gases and lower hydrocarbons, such as methane, ethane and propane, are suitable as such (higher hydrocarbons, e.g. C₄-hydrocarbons, should be avoided). Frequently, steam is also used as a diluent gas. Mixtures of abovementioned gases often form the diluent gas for the partial propene oxidation process.

The heterogeneously catalyzed partial oxidation of propene is advantageously effected in the presence of propane.

Typically, the reaction gas starting mixture for the propene oxidation process has the following composition (molar ratios):

Propene:oxygen:H₂O: other diluent gases=1:(0.1- 10):(0-70):(0:20).

Preferably, the abovementioned ratio is 1:(1-5):(1-40): (0-10).

If propane is used as the diluent gas, it can, as described, advantageously likewise be partially oxidized to acrylic acid.

According to the invention, the reaction gas starting mixture advantageously contains molecular nitrogen, CO, CO₂, steam and propane as diluent gas.

The molar propane:propene ratio in the propene oxidation process may assume the following values: from 0 to 15, frequently from 0 to 10, often from 0 to 5, expediently from 0.01 to 3.

The loading of the catalyst bed with propene in the partial propene oxidation process may be, for example, from 40 to 250 l(S.T.P.) per l per h or more. The loading with reaction gas starting mixture is frequently in the range from 500 to 15 000 l(S.T.P.) per l per h, often in the range from 600 to 10 000 l(S.T.P.) per l per h, frequently from 700 to 5000 l(S.T.P.) per l per h.

Of course, in the process for the partial oxidation of propene to acrylic acid, a product gas mixture which does not consist exclusively of acrylic acid is obtained. Rather, the product gas mixture contains, in addition to unconverted propene, secondary components, such as propane, acrolein, CO₂, CO, H₂O, acetic acid, propionic acid, etc., from which the acrylic acid has to be separated off.

This can be effected in the manner generally known from the heterogeneously catalyzed two-stage gas-phase oxidation (carried out in two reaction zones) of propene to acrylic acid.

This means that the acrylic acid contained can be taken up from the product gas mixture by absorption with water or by absorption with a high-boiling inert hydrophobic organic solvent (for example, a mixture of diphenyl ether and diphyl which, if appropriate, may also comprise additives, such as dimethyl phthalate). The resulting mixture of absorbent and acrylic acid can then be worked up in a manner known per se by rectification, extraction and/or crystallization to give pure acrylic acid. Alternatively, the initial separation of the acrylic acid from the product gas mixture can also be effected by fractional condensation, as described, for example, in DE-A 199 24 532.

The resulting aqueous acrylic acid condensate can then be further purified, for example by fractional crystallization (e.g. suspension crystallization and/or layer crystallization).

The residual gas mixture remaining in the initial isolation of the acrylic acid contains in particular unconverted propene (and possibly propane). This can be separated from the residual gas mixture, for example, by fractional rectification under pressure and then recycled to the gas-phase oxidation according to the invention. However, it is more advantageous to bring the residual gas into contact, in an extraction apparatus, with a hydrophobic organic solvent (for example by passing said gas through) which is capable of preferentially absorbing the propene (and, if appropriate, propane).

By subsequent desorption and/or stripping with air, the absorbed propene (and, if appropriate, propane) can be liberated again and recycled to the process according to the invention. In this way, economical overall propene conversions are achievable. If propene is subjected to partial oxidation in the presence of propane, propene and propane are preferably separated off together and recycled.

In a completely corresponding manner, the multimetal oxides M obtainable according to the invention and their successor materials can be used as catalysts for the partial oxidation of isobutane and/or isobutene to methacrylic acid.

Their use for the ammoxidation of propane and/or propene can be effected, for example, as described in EP-A 529 853, DE-A 23 51 151, JP-A 6-166668 and JP-A 7-232071.

Their use for the ammoxidation of n-butane and/or n-butene can be effected as described in JP-A 6-211767.

Their use for the oxydehydrogenation of ethane to ethylene or the further reaction to acetic acid can be effected as described in U.S. Pat. No. 4,250,346 or in EP-B 261 264.

Their use for the partial oxidation of acrolein to acrylic acid can be effected as described in DE-A 102 61 186.

The multimetal oxide materials M obtainable according to the invention and their successor materials can, however, also be integrated in other multimetal oxide materials (for example, mix, if appropriate compress and calcine their finely divided materials, or mix as slurries (preferably aqueous), dry and calcine (for example as described in EP-A 529 853)). Calcination is once again preferably effected under inert gas.

The resulting multimetal oxide materials (referred to below as total materials) preferably contain ≧50% by weight, particularly preferably ≧75% by weight and very particularly preferably ≧90% by weight or ≧95% by weight of multimetal oxide materials M obtainable according to the invention or of the successor materials thereof and are likewise suitable for the partial oxidations and/or partial ammoxidations discussed in this document.

In the case of the total materials, the geometric shaping is expediently effected as described for the multimetal oxide materials M obtainable according to the invention and the successor materials thereof.

For the purpose of the heterogeneously catalyzed partial gas-phase oxidation of propane to acrylic acid, the multimetal oxide materials M obtainable according to the invention, the successor materials thereof and multimetal oxide materials or catalysts comprising such materials are preferably put into operation as described in DE-A 101 22 027.

Finally, it should be stated that the excellent reproducibility on using the procedure according to the invention is due to the fact that the desired multimetal oxide M is obtained in an environment which comprises substantially only water and its constituents H, O and OH. In this way, the multimetal oxide M is obtained so to speak under its natural pH, which evidently imparts particular robustness to the procedure.

### EXAMPLES AND COMPARATIVE EXAMPLES

### A) Preparation of Multimetal Oxide Materials

### Example 1

### Preparation of a Multimetal Oxide Material of the Stoichiometry Mo₁V_{0.32}Te_{0.027}Oₓ as Weighed in

The following were introduced in finely divided form into an autoclave having a built-in stirrer and an internal volume of 2.5 l:
123.27 g of MoO₃ (Riedel-de-Haen brand, 30926 Seeize; MoO₃ content>99.9%; 0.86 mol of Mo);
23.06 9 of VO₂ (from Alfa Aesar, 76057 Karlsruhe; VO₂ content=99.5%; 0.28 mol of VO₂, V oxidation state=4.03);
3.69 g of TeO₂ (from Sigma Aldrich, 82018 Taufkirchen; >99% of TeO₂; 0.023 mol of TeO₂);
   and 1500 ml of water.

The cover of the autoclave was closed and the portion of air present above the aqueous phase in the autoclave was exchanged for nitrogen by flushing with nitrogen. Thereafter, the autoclave was heated continuously (linearly) to 175° C. with continuous stirring (700 rpm) in the course of 10 hours under autogenous pressure and kept at this temperature with further stirring for 48 hours. It was then cooled to room temperature (25° C.). The autoclave was opened and the black powder formed was filtered off, washed with three times 200 ml of water at a temperature of 25° C. and then dried at 80° C. for 12 hours in a drying oven under reduced pressure.

The experiment carried out in the manner described was repeated ten times. In all cases, the same result, described below, was obtained.

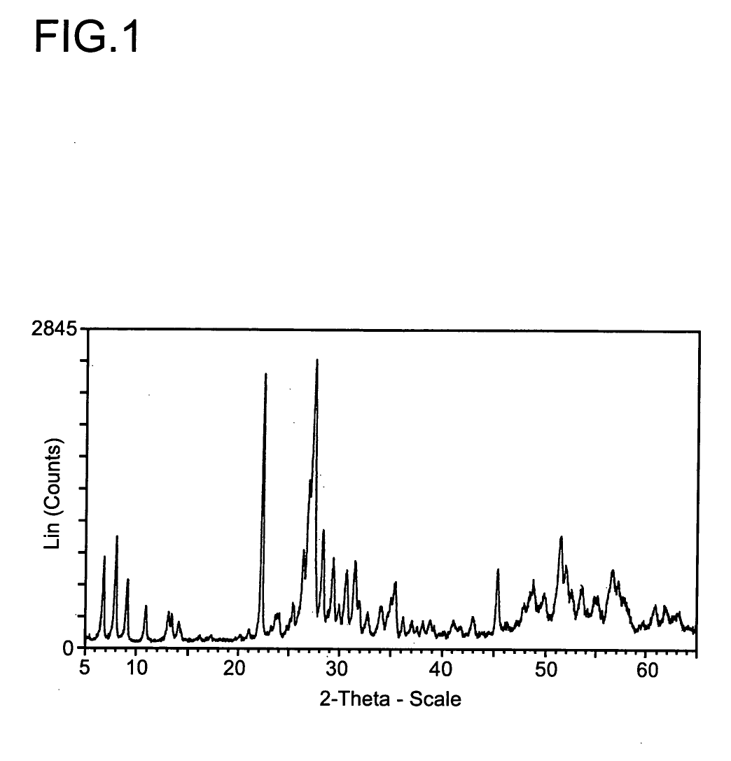

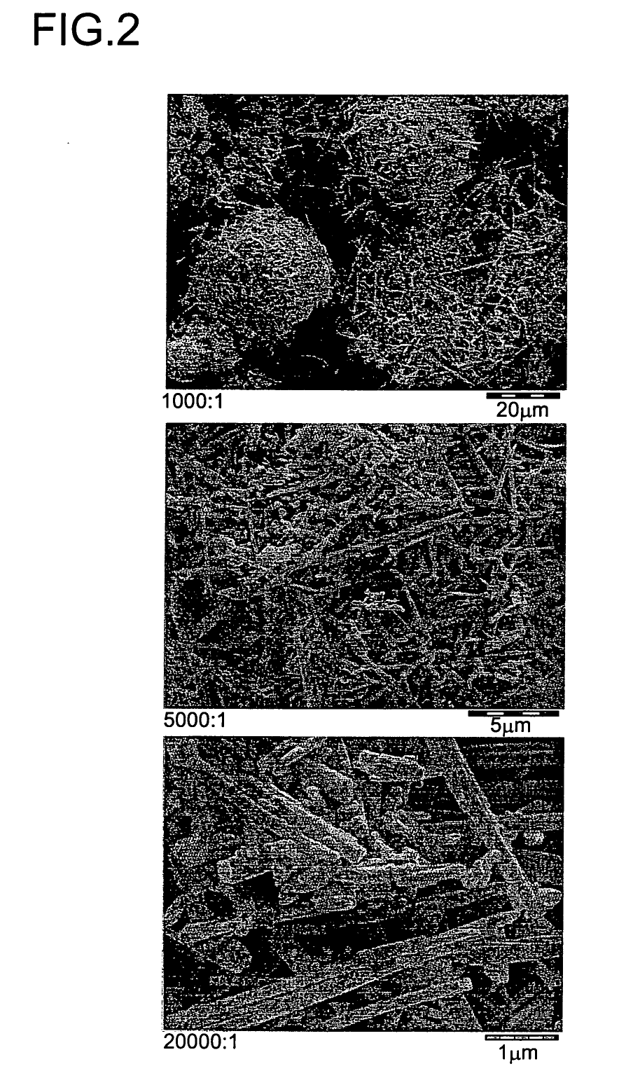

As indicated by the powder X-ray diffractogram (XRD) shown in FIG. 1, exclusively i-phase is obtained. The associated scanning electron micrograph (SEM) (FIG. 2, three different magnifications) shows acicular crystals having a high length-to-thickness ratio of from about 50 to 100.

The advantage of the “acicular” or “fiber form” is likely to lie in the fact that other (additional) crystallographic surfaces are more accessible to the catalysis in comparison with a more isotropic material.

Titrimetric analysis shows that the V in the i-phase formed has the oxidation state 4.02. to 4.05. The specific surface area was 45 m²/g. Chemical analysis gave satisfactory agreement with the stoichiometry as weighed in.

### Comparative Example 1

### Preparation of a Multimetal Oxide Material of the Stoichiometry Mo₁V_{0.32}TeO_{0.027}Oₓ as Weighed in

The following were introduced in finely divided form into the autoclave from example 1:
151.87 g of (NH₄)₆Mo₇O₂₄.4 H₂O (from H. C. Starck, 38642 Goslar; MoO₃ content 81.5%; 0.86 mol of Mo);
66.64 g of vanadyl sulfate hydrate VOSO₄.(H₂O)ₓ (from Alfa Aesar, 76057 Karlsruhe; V content=21.4% by weight; 0.28 mol of V);
3.69 g of TeO₂ (as in example 1);
   and 1500 ml of water.

The procedure was then carried out as in example 1 (hydrothermally). The experiment carried out in the manner described was repeated ten times. In two cases, an increased fraction of the i-phase occurred in the multimetal oxide powder formed. In the eight other experiments, on the other hand, a phase mixture which contained only a small proportion of i-phase was obtained.

The following were identified among the other phases: the phase 81-2414 (c) of the JPDS Index [(V_{0.12}MoO_{0.08})O_{2.94}, hexagonal], the phase 05-0508 of the JPDS Index [MoO₃, orthorhombic], the phase 47-0872 of the JPDS Index [HMo_{5.35}O_{15.75}(OH)_{1.6}.1.7 H₂O] and the phase 77-0649 (c) of the JPDS Index [(V_{0.95}Mo_{0.97})O₅, triclinic].

### Example 2

### Preparation of a Multimetal Oxide Material of the Stoichiometry Mo₁V_{0.32}Bi_{0.027}Oₓ as Weighted in

The following were introduced in finely divided form into the autoclave from example 1:
123.27 g of MoO₃ (as in example 1);
23.06 g of VO₂ (as in example 1);
5.36 9 of Bi₂O₃ (Riedel-de Haen brand, 30926 Seeize; ≧99.5% of Bi₂O₃; 0.023 mol of Bi);
   and 1500 ml of water.

The procedure was then carried out as in example 1 (hydrothermally).

The experiment carried out in the manner described was repeated ten times. In all cases, the same result, described below, was obtained.

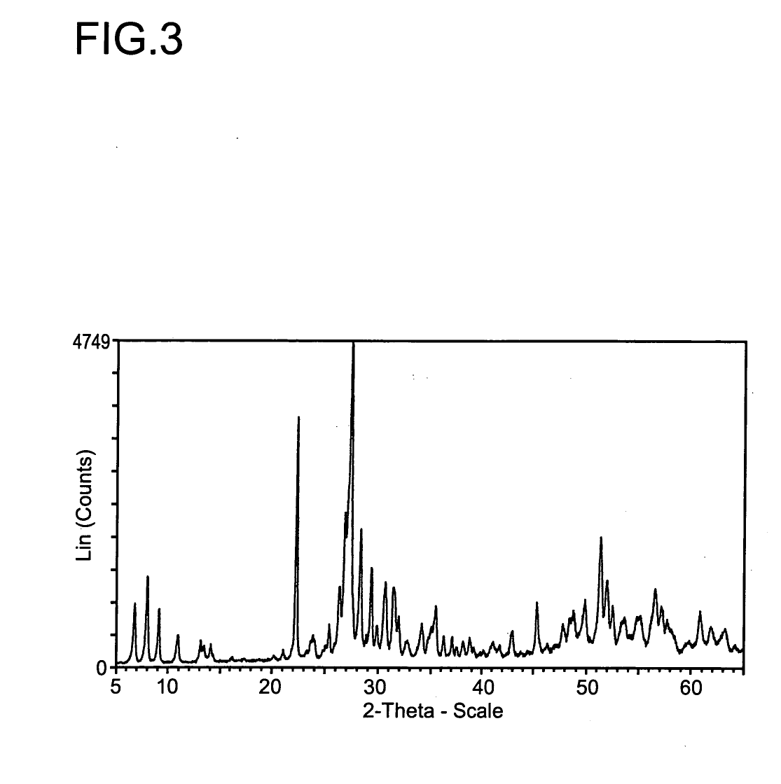

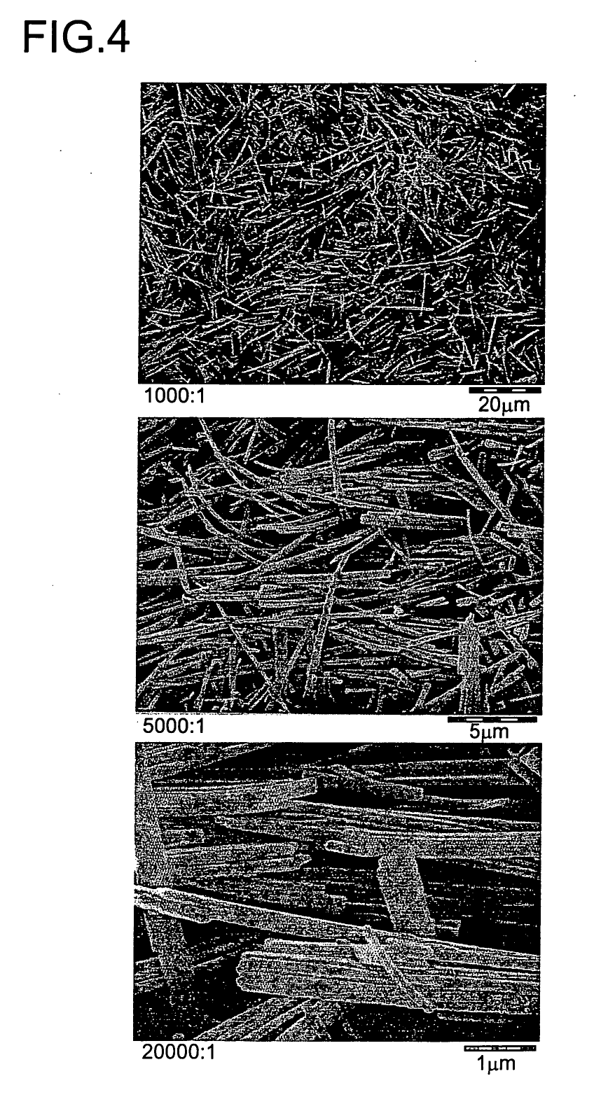

The powder X-ray diffractogram (cf. FIG. 3) comprised exclusively i-phase in all cases for the black powder obtained. The associated scanning electron micrograph (FIG. 4, three different magnifications) shows acicular crystals having a high length-to-thickness ratio of from about 30 to 150.

The chemical analysis gave satisfactory agreement with the stoichiometry as weighed in. According to titrimetric analysis, the V in the i-phase formed had the oxidation state 4.02 to 4.07. The specific surface area was 38 m²/g.

### Comparative Example 2

### Preparation of a Multimetal Oxide Material of the Stoichiometry Mo₁V_{0.32}Bi_{0.027}Oₓ as Weighted in

The procedure was as in example 2. However, 151.87 g of (NH₄)₆Mo₇O₂₄.4H₂O (as in comparative example 1) were used instead of MoO₃ and 66.64 g of vanadyl sulfate hydrate (VOSO₄.(H₂O)ₓ) (as in comparative example 1) were used instead of VO₂. The experiment was repeated ten times. In two cases, an increased proportion of i-phase in the prepared black powder was obtained.

In the other eight reproductions, on the other hand, a phase mixture having only a small proportion of i-phase was obtained. The remaining phases were identifiable as phase 05-0508 of the JPDS Index [MoO₃, orthorhombic], as phase 47-0872 of the JPDS Index [HMo_{5.35}O_{15.75}(OH)_{1.6}.1.7 H₂O], as phase 48-0744 of the JPDS Index (BiVO₄, tetragonal), as phase 85-0630 of the JPDS Index (Bi_{0.88}Mo_{0.37}V_{0.63}O₄), as the crystal structure of the phase 70-2321 (c) of the JPDS Index [Sb₂Mo₁₀O₃₁, orthorhombic], as the crystal structure of the phase 33-0104 of the JPDS Index (Sb₄Mo₁₀O₃₁, hexagonal) and/or phase 77-0649 (c) of the JPDS Index [(V_{0.95}Mo_{0.97}O₅, triclinic]. In addition, further phases were present in some cases and could not be further identified on the basis of the XRD reflections.

### Example 3

### Preparation of a Multimetal Oxide Material of the Stoichiometry Mo₁V_{0.32}Bi_{0.027}Oₓ as Weighted in

The procedure was as in example 2. However, the vanadium source used was a mixture of 2.85 g of V powder (from Chempur, 76204 Karlsruhe; V content>99.5%; 0.056 mol of V) and 20.36 g of V₂O₅ (from Gesellschaft für Elektrometallurgie (GfE), 90431 Nürnberg; V₂O₅ content=99.97%; 0.224 mol of V).

The autoclave was closed and the portion of air present above the aqueous solution in the autoclave was exchanged for nitrogen by flushing with nitrogen. appropriate, propane) can be liberated again and recycled to the process according to

Thereafter, the autoclave was heated continuously (linearly) to 90° C. with continuous stirring (700 rpm) and under autogenous pressure over the course of 3 hours and stirred for 10 hours at this temperature.

Thereafter, it was heated continuously (linearly) to 175° C. in the course of 8 hours with continuous stirring (700 rpm) and under autogenous pressure and kept at this temperature with stirring for 24 hours. Thereafter, it was cooled to room temperature (25° C.) and, as in example 1, the black powder formed was filtered off, washed with water and dried.

The experiment carried out in the manner described was repeated ten times. In six of the 10 procedures, the same result as in example 2 was obtained.

In four of the ten procedures, the solids which corresponded to those from comparative example 2 crystallized.

### Example 4

### Preparation of a Multimetal Oxide Material of the Stoichiometry Mo₁V_{0.25}Oₓ as Weighed in

The procedure was as in example 1. However, only 18.0 g of VO₂ were used instead of 23.06 g of VO₂, and the Te compound was omitted.

### Example 5

### Preparation of a Multimetal Oxide Material of the Stoichiometry Mo₁V_{0.25}Nb_{0.098}Bi_{0.042}Oₓ as Weighted in

The procedure was as in example 1, i.e. once again 123.27 9 of MoO₃ were weighed in, and the amounts of VO₂, Nb₂O₅ and Bi₂O₃ necessary in this respect according to the required stoichiometry.

### Exampel 6

### Preparation of a Multimetal Oxide Material of the Stoichiometry Mo₁V_{0.3}Sb_{0.25}Nb_{0.12}Oₓ as Weighed in

The procedure was as in example 1, i.e. once again 123.27 g of MoO₃ were weighed in, and the amounts of VO₂, Sb₂O₃ and Nb₂O₅ necessary in this respect according to the required stoichiometry.

### Example 7

### Preparation of a Multimetal Oxide Material of the Stoichiometry Mo₁V_{0.3}Nb_{0.13}Sb_{0.13}O_{4.125} as Weighted in

The procedure was as in example 1, i.e. once again 123.27 g of MoO₃ were weighed in, and the amounts of VO₂, Nb₂O₅ and Sb₂O₃ necessary in this respect according to the required stoichiometry.

### Example 8

### Preparation of a Multimetal Oxide Material of the Stoichiometry Mo₁V_{0.3}Nb_{0.13}Ni_{0.13}Oₓ as Weighted in

The procedure was as in example 1, i.e. once again 123.27 g of MoO₃ were weighed in, and the amounts of VO₂, Nb₂O₅ and NiO necessary in this respect according to the required stoichiometry.

### Example 9

### Preparation of a Multimetal Oxide Material of the Stoichiometry Mo₁V_{0.3}Nb_{0.13}Co_{0.13}Oₓ as Weighted in

The procedure was in example 1, i.e. once again 123.27 g of MoO₃ were weighed in, and the amounts of VO₂, Nb₂O₅ and CoO necessary in this respect according to the required stoichiometry.

### Example 10

### Preparation of a Multimetal Oxide Material of the Stoichiometry Mo₁V_{0.3}Nb_{0.13}Cf_{0.031}Oₓ as Weighed in

The procedure was as in example 1, i.e. once again 123.27 9 of MoO₃ were weighed in, and the amounts of VO₂, Nb₂O₅ and Cr₂O₃ necessary in this respect according to the required stoichiometry.

### Example 11

### Preparation of a Multimetal Oxide Material of the Stoichiometry Mo₁V_{0.32}Bi_{0.027}Oₓ as Weighed in

The procedure was as in example 2. 100 g of the multimetal oxide material obtained and dried were added to 500 g of a 10% strength by weight aqueous nitric acid. The resulting aqueous suspension was stirred under reflux at 80° C. for 5 hours. It was then cooled to 25° C. The solid present in the black suspension was separated from the aqueous phase by filtration, washed nitrate-free with water and then dried in a through-circulation drying oven at 120° C. overnight.

### Example 12

The procedure was as in example 2. 100 g of the multimetal oxide material obtained and dried were heated from room temperature to 500° C. at a heating rate of 2° C./min under a stream of molecular nitrogen (10 l(S.T.P.)/h) in a rotary bulb furnace (internal volume: 1 liter) according to FIG. 1 of DE-A 100 29 338, and this temperature was maintained for 6 hours while maintaining the stream of nitrogen. Cooling to 25° C. was then effected by leaving to stand while maintaining the stream of nitrogen.

### Example 13

As for example 5, except that thermal aftertreatment was effected as in example 12.

### Example 14

As for example 6, except that thermal aftertreatment was effected as in example 12.

### Example 15

As for example 7, except that thermal aftertreatment was effected as in example 12.

### Example 16

As for example 10, except that thermal aftertreatment was effected as in example 12.

### B) Preparation of Coated Catalysts from the Multimetal Oxide Materials Prepared in A)

The respective active material powder was milled in a Retsch mill (centrifugal mill, type ZM 100, from Retsch, Germany) (particle size ≦0.12 mm).

In each case 38 g of the powder present after milling were applied to 150 g of spherical supports having a diameter of from 2.2 to 3.2 mm (Rz=45 μm, support material=steatite C 220 from Ceramtec, Germany, total pore volume of the support≦1% by volume, based on the total support volume). For this purpose, the support was initially taken in a coating drum having an internal volume of 2 l (angle of inclination of the central axis of the drum relative to the horizontal=30°). The drum was caused to rotate at 25 revolutions per minute. About 25 ml of a mixture of glycerol and water (glycerol: water weight ratio=1:3) were sprayed onto the support over 60 minutes via an atomizer nozzle operated with 300 l(S.T.P.)/h of compressed air. The nozzle was installed in such a way that the spray cone wet the supports transported in the drum by metal driver plates at the uppermost point of the inclined drum in the upper half of the rolling path. The finely divided active material powder was introduced into the drum via a powder screw, the point of addition of the powder being within the rolling path or below the spray cone. By periodically repeating wetting and powder metering, the support provided with a base coat itself became the support in the subsequent period.

After the end of the coating, the coated support was dried under air for 16 hours at 150° C. in a muffle furnace.

The coated catalysts SB1 to SB16 and SVB1 and SVB2, each containing 20% by weight of active material, resulted (B1 means that the multimetal oxide according to example 1 from A) was used; SVB1 accordingly means that the multimetal oxide according to comparative example 1 from A) was used).

### C) Testing of the coated catalysts prepared in B)

A tubular reactor produced from steel (internal diameter: 8.5 mm, length: 140 cm, wall thickness: 2.5 cm) was loaded with in each case 35.0 g of the respective coated catalyst from B) (catalyst bed length in all cases about 53 cm). A preliminary 30 cm bed of steatite beads (diameter: from 2.2 to 3.2 mm, manufacturer: Ceramtec, steatite C 220) was installed before the catalyst bed, and a subsequent bed of the same steatite beads was installed after the catalyst bed, over the remaining length of the tubular reactor.

The external temperature T of the loaded reaction tube was brought externally to the desired value over the entire length by means of electrically heated heating mats.

The reaction tube was then fed with a reaction gas starting mixture having the molar composition propane: air: H₂O=1:15:14 (the entry side was on the side of the subsequent bed). The residence time (based on the catalyst bed volume) was brought to 2.4 seconds. The entry pressure was 2 bar absolute.

The reaction tube bed was first run in in each case at an external temperature T=350° C. of the loaded reaction tube over a period of 24 hours before this external temperature was brought to its respective value.

The table below shows the resulting propane conversion (C^{PAN}(mol %)), the resulting selectivity of the acrylic acid formation (S_{ACA} (mol %)) and the selectivity of the formation of the propene byproduct (S_{PEN} (mol %)), as a function of the coated catalyst used and of the external temperature T (° C.) set.

TABLE

| Coated | | | | |
|---|---|---|---|---|
| catalyst | T[° C.] | C^{PAN} (mol %) | S_{ACA} (mol %) | S_{PEN} (mol %) |
| SB4 | 420 | 11 | 45 | 30 |
| SB2 | 280 | 17 | 30 | 7 |
| SB11 | 280 | 26 | 27 | 5 |
| SB12 | 280 | 11 | 34 | 9 |
| SB5 | 300 | 28 | 22 | 4 |
| SB13 | 310 | 21 | 26 | 6 |
| SB6 | 390 | 36 | 29 | 6 |
| SB14 | 320 | 11 | 39 | 19 |
| SB7 | 352 | 25 | 23 | 5 |
| SB15 | 360 | 10 | 23 | 21 |
| SB8 | 310 | 15 | 25 | 8 |
| SB9 | 310 | 13 | 28 | 10 |
| SB10 | 300 | 23 | 19 | 4 |
| SB16 | 310 | 22 | 23 | 6 |

U.S. Provisional Patent Application No. 60/577, 929, filed on Jun. 9, 2004, is included in the present Application by reference to the literature. In view of the abovementioned teachings, numerous modifications of and deviations from the present invention are possible. It may therefore be assumed that, within the scope of the attached claims, the invention can be carried out in a manner differing from that specifically described herein.

1. A process for the preparation of a multimetal oxide material M of the general stoichiometry I
Mo₁VₐM¹_{b}M²_{c}M³_{d}M⁴ₑOₙ (I)
where
M¹=at least one of the elements from the group consisting of Al, Ga, In, Ge, Sn, Pb, As, Bi, Se, Te and Sb;
M²=at least one of the elements from the group consisting of Sc, Y, La, Ti, Zr, Hf, Nb, Ta, Cr, W, Mn, Fe, Co, Ni, Zn, Cd and the lanthanides;
M³=at least one of the elements from the group consisting of Re, Ru, Rh, Pd, Os, Ir, Pt, Cu, Ag, Au;
M⁴=at least one of the elements from the group consisting of Li, Na, K, Rb, Cs, Be, Mg, Ca, Sr, Ba, NH₄ and TI;
a=from 0.01 to 1;
b=from ≧0to1;
c=from ≧0 to 1;
d=from ≧0 to 0.5;
e=from ≧0 to 0.5 and
n=a number which is determined by the valency and frequency of the elements other than oxygen in (I),
in which a mixture g of sources of the elemental constituents of the multimetal oxide material M is subjected to a hydrothermal treatment and the new solid forming thereby is separated off, wherein
exclusively sources from the group consisting of compounds which consist only of the elemental constituents of the multimetal oxide material m and of elemental constituents of water, the elemental constituents of the multimetal oxide material: M itself in their elemental form and ammonium salts containing elemental constituents of the multimetal oxide material M are used as sources of the elemental constituents of the multimetal oxide material M, with the proviso that the molar ratio MR NH₄/Mo of NH₄ contained in the mixture G. and Mo contained in the mixture G is ≦0.5 and at least a portion of the sources comprises the elemental constituents contained in these sources with an oxidation number which is below the maximum oxidation number of the respective elemental constituent.

2. The process according to claim 1, which is carried out at a temperature of from 120 to 300° C.

3. The process according to claim 1 or 2, which is carried out at a pressure of from >1 bar to 500 bar.

4. The process according to any of claims 1 to 3, wherein at least a portion of the sources of the elemental constituent V comprises vanadium whose oxidation number is +4 or +3 or +2 or 0.

5. The process according to any of claims 1 to 4, wherein at least one of the compounds from the group consisting of VO₂, V₂O₃, VO, V₆O₁₃, V₃O₇, V₄O₉ and elemental vanadium is concomitantly used as a source of the elemental constituent V.

6. The process according to any of claims 1 to 5, wherein the molar ratio MR is ≦0.3.

7. The process according to any of claims 1 to 6, wherein the molar ratio MR is ≦0.1.

8. The process according to any of claims 1 to 7, wherein at least 40 mol % of the V contained in the mixture G is contained as V whose oxidation number is <+5.

9. The process according to any of claims 1 to 7, wherein at least 70 mol % of the V contained in the mixture G is contained as V whose oxidation number is <+5.

10. The process according to any of claims 1 to 9, wherein the stoichiometric coefficients a, b, c and d are simultaneously within the following ranges:
a=from 0.05 to 0.5;
b=from 0.01 to 0.5;
c=from 0.01 to 0.5;
d=from 0.0005 to 0.5 and
e=from ≧0 to 0.5.

11. The process according to any of claims 1 to 9, wherein the stoichiometric coefficients a, b, c and d are simultaneously within the following ranges:
a=from 0.1 to 0.5;
b=from 0.1 to 0.5;
c=from 0.1 to 0.5;
d=from 0.001 to 0.1 and
e=from ≧0 to 0.1.

12. The process according to any of claims 1 to 11, wherein M³ is at least one element from the group consisting of Sb, Bi, Se and Te.

13. The process according to any of claims 1 to 12, wherein at least 50 mol % of the total amount of M² is Nb and at least one of the elements from the group consisting of Ti, Zr, Cr, Ta, W, Fe, Co, Ni and Zn.

14. The process according to any of claims 1 to 13, wherein M³ is at least one element from the group consisting of Re, Pd and Pt.

15. The process according to any of claims 1 to 14, wherein the stoichiometric coefficient e is 0.

16. A process for the preparation of a multimetal oxide material M of the general stoichiometry I from claim 1, wherein first a process according to any of claims 1 to 15 is carried out, the new solid forming is separated off and subjected to a thermal aftertreatment and then, if appropriate, is washed with an organic acid or an aqueous solution thereof or with an inorganic acid or an aqueous solution thereof or with an alcohol or with hydrogen peroxide or an aqueous solution thereof.

17. A process for the preparation of a multimetal oxide material M of the general stoichiometry I from claim 1, wherein first a process according to any of claims 1 to 15 is carried out, the new solid forming is separated off and is then washed with an organic acid or an aqueous solution thereof or with an inorganic acid or an aqueous solution thereof or with an alcohol or with hydrogen peroxide or an aqueous solution thereof.

18. The process according to any of claims 1 to 15, which is carried out under an inert gas atmosphere.

19. The process according to any of claims 1 to 17, wherein the thermal aftertreatment and the washing are carried out under an inert gas atmosphere.

20. The process according to any of claims 1 to 15, wherein, based on the sum of water and the sources of the elemental constituents of the multimetal oxide material M, the proportion by weight of the latter in the hydrothermal treatment is from 5 to 50% by weight.
